(19) United States
(12) Patent Application Publication
(10) Pub. No.: US 2025/0087836 A1
(43) Pub. Date: Mar. 13, 2025

(54) POWER STORAGE DEVICE AND METHOD FOR MANUFACTURING THE POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yozo UCHIDA, Toyota-shi (JP); Satoshi FUJIMURA, Toki-shi (JP); Yuki SATO, Toyota-shi (JP); Nozomi TATEYAMA, Okazaki-shi (JP); Masahiro UCHIMURA, Miyoshi-shi (JP); Masataka ASAI, Toyota-shi (JP); Shigeru MATSUMOTO, Toyohashi-shi (JP); Takashi TAKIMOTO, Kosai-shi (JP); Shunsuke NAKAMURA, Hamamatsu-shi (JP); Keitaro MACHIDA, Hamamatsu-shi (JP)

(21) Appl. No.: 18/677,883

(22) Filed: May 30, 2024

(30) Foreign Application Priority Data
Sep. 11, 2023 (JP) 2023-147107

(51) Int. Cl. H01M 50/486; H01M 10/04; H01M 50/188; H01M 50/474

(52) U.S. Cl. CPC H01M 50/486; H01M 10/04; H01M 50/188; H01M 50/474

(57) ABSTRACT

A power storage device includes a case lid with a terminal inserting hole, a current collecting terminal having a hole insertion portion inserted in the terminal inserting hole and an external connection portion placed on a front surface side of the case lid, and an insulating resin member integrally molded with the current collecting terminal and the case lid. The insulating resin member includes an outer-periphery-side insulating resin portion and a back-surface side insulating resin portion connecting the current collecting terminal and the case lid. The back-surface side insulating resin portion is formed with a hollow portion penetrating through a back surface of the back-surface side insulating resin portion to a back surface of the outer connecting portion. The back surface of the outer connecting portion is formed with an annular band-shaped sealing portion along the outer edge portion of the hollow portion.

### CROSS-REFERENCE TO RELATED APPLICATIONS

This application is based upon and claims the benefit of priority to Japanese Patent Application No. 2023-147107 filed on Sep. 11, 2023, the entire contents of which are incorporated herein by reference.

### BACKGROUND

### Technical Field

The disclosure relates to a power storage device and a method for manufacturing the same.

### Related Art

For example, Japanese unexamined patent application publication No. 2021-086813 discloses a sealed power storage device in which an insulating resin member is integrally molded with a current collecting terminal and a case member (insert molding) so as to fill the space between the current collecting terminal and a terminal inserting hole of the case member.

### SUMMARY

### Technical Problems

However, when the current collecting terminal has such a shape that an outer connecting portion placed on the front surface side of the case member is bent with respect to a hole insertion portion inserted in the terminal inserting hole of the case member, the bending angle of the outer connecting portion to the hole insertion portion tends to vary for each current collecting terminal, which may cause the following problems. During injection molding to integrally mold the insulating resin member with the current collecting terminal and the case member, molten resin forming the insulating resin member may enter into a gap between the front, or top, surface of the outer connecting portion with the bending angle that varies for each terminal as above and a mold contact portion of a mold, causing the generation of resin burrs of the insulating resin member on the front surface of the outer connecting portion.

The disclosure has been made to address the above problems and has a purpose to provide a power storage device and a method for manufacturing the same, capable of avoiding or reducing the generation of resin burrs of an insulating resin member, which is integrally molded with a current collecting terminal and a case member, on the front surface of an outer connecting portion of the current collecting terminal.

### Means of Solving the Problems

(1) To achieve the above-mentioned purpose, one aspect of the present disclosure provides a power storage device comprising: a case member having a terminal inserting hole; a current collecting terminal including: a hole insertion portion inserted through the terminal inserting hole in a case front-back direction of the case member; and an external connection portion bent with respect to the hole insertion portion and placed on a front surface side of the case member; and an insulating resin member integrally molded with the current collecting terminal and the case member, in which the hole insertion portion and the external connection portion are connected to a hole outer edge portion and a hole surrounding portion of the terminal inserting hole of the case member, wherein the insulating resin member includes: an outer-periphery-side insulating resin portion surrounding an entire outer periphery edge of the outer connecting portion; and a back-surface side insulating resin portion connecting a back surface of the outer connecting portion and the hole insertion portion to the hole outer edge portion and the hole surrounding portion, the back-surface side insulating resin portion is formed with a hollow portion penetrating from a back surface of the back-surface side insulating resin portion to the back surface of the outer connecting portion in the case front-back direction, and the back surface of the outer connecting portion is formed with a sealing portion extending in an annular band shape along an outer edge portion of the hollow portion.

(2) In the power storage device described in (1), a front surface of the outer connecting portion and a front surface of the outer-periphery-side insulating resin portion may be flush with each other, and the outer connecting portion and the outer-periphery-side insulating resin portion may have a recessed groove formed on a boundary line between them.

(3) Another aspect of the disclosure provides a method for manufacturing the power storage device described in the above configuration (1) or (2), using a mold including a fixed mold and a movable mold, each having a mold contact portion to be placed in contact with the current collecting terminal and the case member, and a cavity in which molten resin is to be charged to form the insulating resin member, wherein the movable mold includes a pressing part configured to press the outer connecting portion toward a case front-surface side, and wherein the method comprises: placing the current collecting terminal and the case member in the mold so that the mold contact portions contact with the current collecting terminal and the case member; and charging the molten resin into the cavity while pressing the back surface of the outer connecting portion on an inner circumferential side of the sealing portion by the pressing part.

### BRIEF DESCRIPTION OF THE DRAWINGS

FIG. 1 is an exploded perspective view showing one form (an example) of a power storage device in an embodiment;

FIG. 2 is a partial perspective view of a part A shown in FIG. 1, which is viewed obliquely from a case back-surface side;

FIG. 3 is a cross-sectional view of a part of the power storage device in the embodiment, which is cut along a line B-B in FIG. 1;

FIG. 4 is a cross-sectional view of a part of a power storage device in a comparative example, which is cut along the line B-B in FIG. 1;

FIG. 5 is a cross-sectional view of a mold used in a method for manufacturing the power storage device shown in FIG. 1; and

FIG. 6 is a cross-sectional view of a part of a power storage device in a modified example, which is cut along the line B-B in FIG. 1.

### DETAILED DESCRIPTION OF THE EXEMPLARY EMBODIMENTS

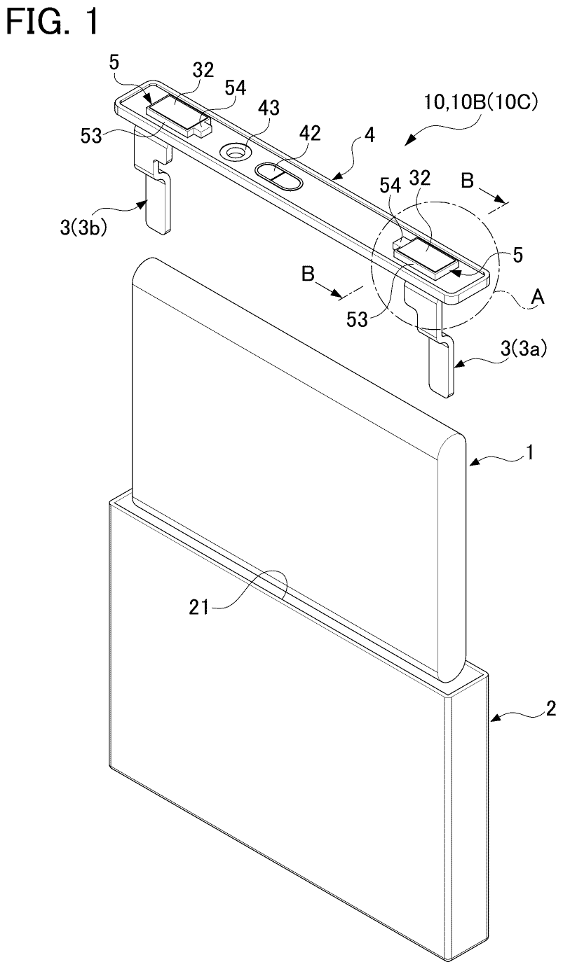

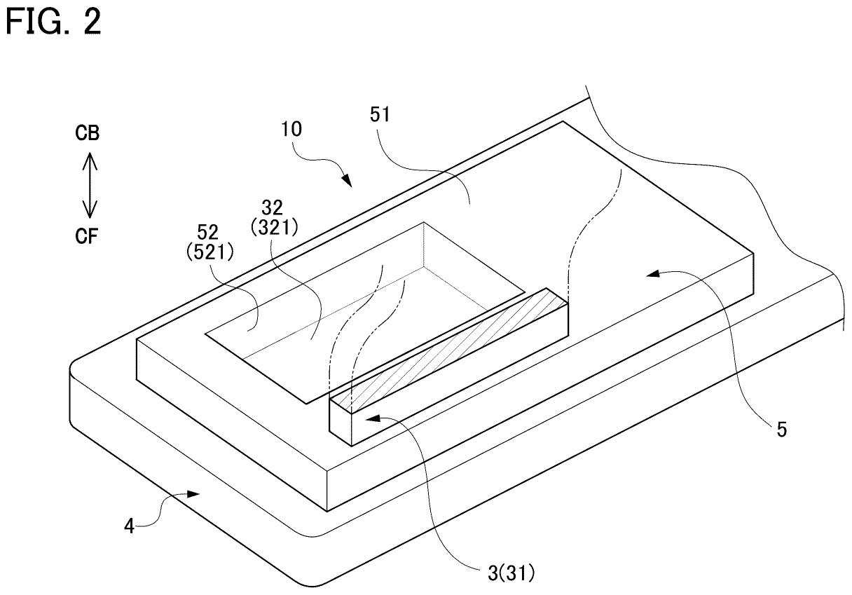

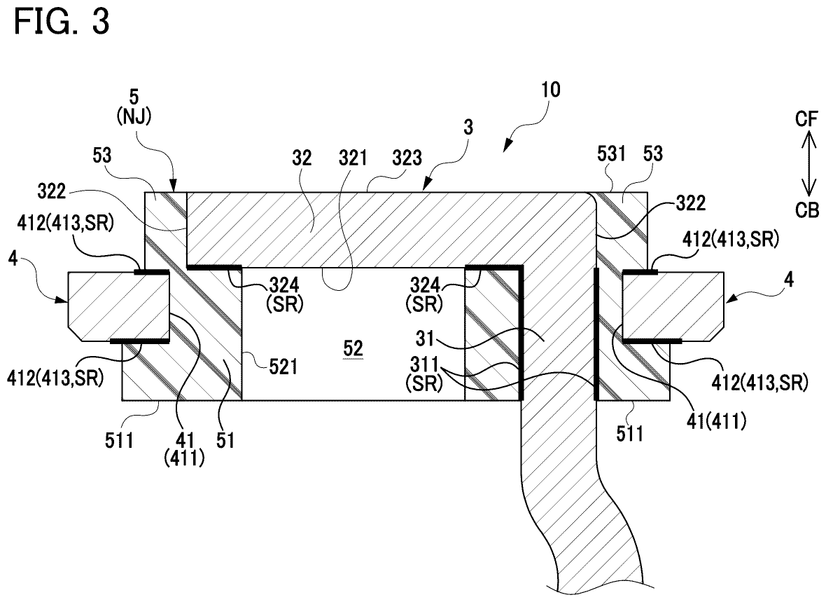

A detailed description of a power storage device 10, which is one form of typical embodiments of this disclosure, will now be given referring to the accompanying drawings. FIG. 1 is an exploded perspective view showing one form (an example) of the power storage device 10 in the embodiment. FIG. 2 is a partial perspective view of a part A in FIG. 1, which is viewed obliquely from a case back-surface side. FIG. 3 is a cross-sectional view of a part of the power storage device 10, which is cut along a line B-B in FIG. 1.

In the present embodiment, as shown in FIGS. 1 to 3, the power storage device 10 is provided with a case lid 4 (one example of a case member of the disclosure), current collecting terminals 3, and insulating resin members 5 each integrally molded (e.g., insert-molded) with the corresponding current collecting terminal 3 and the case lid 4. The case lid 4 includes a pair of terminal inserting holes 41, one near each end in a longitudinal direction of the case lid 4. The current collecting terminals 3 each include a hole insertion portion 31 inserted in the corresponding terminal inserting hole 41 in a case front-back direction, which is for example an inside-outside direction of the power storage device 10 shown as an upper-lower direction in FIG. 3, and an external connection portion 32 bent with respect to the hole insertion portion 31 and placed on a front (i.e., outer) surface side of the case lid 4. The external connection portion 32 has a rectangular shape in a plan view seen from a case front-surface side CF, which corresponds to the outside of the power storage device 10 in the figures, to enable connection with a busbar and the like not shown. The terminal inserting hole 41 is formed with a size that allows insertion of the hole insertion portion 31 and the external connection portion 32 of the current collecting terminal 3 in the case front-back direction. The external connection portion 32 is bent at a right angle to the hole insertion portion 31, but not limited thereto.

Further, as shown in FIG. 3, the insulating resin member 5 is integrally molded with the current collecting terminal 3 and the case lid 4 (insert molding), in which the hole insertion portion 31 and the external connection portion 32 of the current collecting terminal 3 are connected to a hole outer edge portion 411 and hole surrounding portions 412 of the case lid 4. The insulating resin member 5 is provided with a back-surface side insulating resin portion 51, which connects the back surface 321 of the external connection portion 32 and the hole insertion portion 31 of the current collecting terminal 3 to the hole outer edge portion 411 and the hole surrounding portions 412 of the case lid 4. The hole insertion portion 31 of the current collecting terminal 3 and the hole surrounding portions 412 of the case lid 4 are formed respectively with roughened surfaces 311 and 413 each extending in an annular band shape with an arithmetic mean roughness in a range of 30 nm to 500 nm, for example, to make sealing portions SR with respect to the insulating resin member 5.

The insulating resin member 5 is further provided with an outer-periphery-side insulating resin portion 53, which surrounds an outer periphery edge 322 of the external connection portion 32 over the entire circumference on the case front-surface side CF of the case lid 4. Furthermore, the external connection portion 32 has a front surface (i.e., an upper surface in FIG. 3) 323 located on the case front-surface side CF, and the outer-periphery-side insulating resin portion 53 has a front surface (i.e., an upper surface in FIG. 3) 531 located on the case front-surface side CF. Those front surfaces 323 and 531 are formed flush with each other. The outer-periphery-side insulating resin portion 53 is formed with a resin injection portion (a gate portion) 54 at the position close to the center of the case lid 4, corresponding to a gate of a mold for injection of resin material that forms the insulating resin member 5.

The power storage device 10 in this embodiment includes an electrode body 1, a case body 2 having an opening 21 and housing the electrode body 1, the current collecting terminals 3 electrically connected to the electrode body 1, the case lid 4 having the terminal inserting holes 41 in which the current collecting terminals 3 are inserted and holding the electrode body 1 via the current collecting terminals 3 and closing the opening 21 of the case body 2, and the insulating resin member 5 integrally molded with the current collecting terminals 3 and the case lid 4 (insert molding) to connect the hole insertion portion 31 and the external connection portion 32 of each current collecting terminal 3 to the hole outer edge portion 411 and the hole surrounding portions 412 of the corresponding terminal inserting hole 41. However, the power storage device 10 is not necessarily limited to the above configuration. For example, the terminal inserting holes 41 may be formed in the case body 2. In the embodiment, the case body 2 and the case lid 4 constitute a case of the power storage device 10.

The power storage device 10 represents all power storage devices from which electrical energy can be extracted; for example, primary batteries, secondary batteries, and electric double layer capacitors. The electrode body 1 is a known electrode body in which a positive electrode sheet or plate with a positive active material layer and a negative electrode sheet or plate with a negative active material layer are wound or stacked by interposing separators therebetween. The case body 2 has a bottomed rectangular tube shape with the opening 21 at the upper end, and is made of aluminum or aluminum alloy, for example. The current collecting terminals 3 include a positive current collecting terminal 3a connected to a positive electrode side of the electrode body 1 and a negative current collecting terminal 3b connected to a negative electrode side of the electrode body 1. The positive current collecting terminal 3a is made of for example aluminum or aluminum alloy and the negative current collecting terminal 3b is made of for example copper or copper alloy. The case lid 4 is formed as a flat plate-like lid member made of aluminum or aluminum alloy, for example. This case lid 4 is formed with the terminal inserting holes 41 in which the current collecting terminals 3 are inserted in a one-to-one correspondence, a known safety valve 42, and a liquid inlet 43 for injection of an electrolyte.

The insulating resin member 5 has a thermoplastic resin material NJ having heat resistance, moldability, insulating property, sealing property, resistance to the electrolyte, and others. The thermoplastic resin material NJ in this embodiment is polyphenylene sulfide (PPS) resin, but is not limited thereto. Further, the thermoplastic resin material NJ forming the insulating resin member 5 may contain reinforcing materials, such as glass fibers, or elastomers, so on.

In the current collecting terminal 3 including the hole insertion portion 31 inserted in the terminal inserting hole 41 in the case front-back direction and the outer connecting portion 32 placed on the front surface side of the case lid 4, the outer connecting portion 32 is bent with respect to the hole insertion portion 31, as described above. Accordingly, the bending angle of the outer connecting portion 32 with respect to the hole insertion portion 31 is liable to vary for each current collecting terminal. Therefore, the back-surface side insulating resin portion 51 is formed with a hollow portion 52 penetrating from the back surface 511 of the back-surface side insulating resin portion 51 to the back surface 321 of the outer connecting portion 32 in the case front-back direction. Accordingly, during injection molding to integrally mold the insulating resin member 5 with the current collecting terminal 3 and the case lid 4, a mold in a closed state can press a region of the back surface 321 of the outer connecting portion 32, which is located on the inner side of the hollow portion 52, toward the case front-surface side CF to reduce a gap between the front surface 323 of the outer connecting portion 32 and a mold contact portion of the mold to zero or minute. Consequently, the molten resin YJ, which forms the insulating resin member 5, is not allowed to enter into the gap between the front surface 323 of the outer connecting portion 32 and the mold contact portion of the mold. This can avoid or reduce the generation of resin burrs JB extending from the outer-periphery-side insulating resin portion 53 onto the front surface 323 of the outer connecting portion 32.

Further, the hollow portion 52 is formed in a rectangular shape as viewed from a case back-surface side CB, which corresponds to the inside of the power storage device 10 in the figures. The outer connecting portion 32 is formed, on the back surface 321, with a roughened surface 324 extending in an annular band shape along an outer edge portion 521 defining the hollow portion 52. This annular band-shaped roughened surface 324 has an arithmetic mean roughness of 30 to 500 nm, for example, and constitutes a sealing portion SR with the insulating resin member 5. Thus, the hermeticity of the back-surface side insulating resin portion 51 around the hollow portion 52 can be ensured.

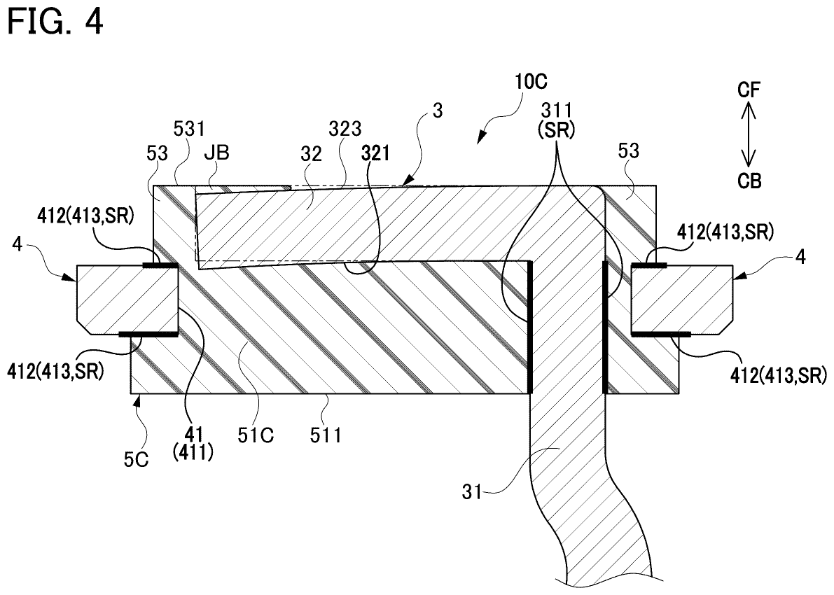

In contrast, FIG. 4 is a part of a power storage device 10C in a comparative example, which is cut along the line B-B in FIG. 1. In this power storage device 10C in the comparative example, as shown in FIG. 4, a back-surface side insulating resin portion 51C connecting the back surface 321 of the external connection portion 32 and the hole insertion portion 31 of the current collecting terminal 3 to the hole outer edge portion 411 and the hole surrounding portions 412 of the case lid 4 is not formed with the hollow portion 52 shown in FIGS. 2 and 3. Further, the back surface 321 of the outer connecting portion 32 is not formed with the annular band-shaped roughened surface 324 (the sealing portion SR) along the outer edge portion 521 of the hollow portion 52. The power storage device 10C in the comparative example is identical in structure to the foregoing power storage device 10 in the present embodiment, except for the hollow portion 52 and the roughened surface 324 (the sealing portion SR), and therefore assigned the same reference signs as those of the power storage device 10.

The power storage device 10C in the comparative example is not formed with the hollow portion 52 in the back-surface side insulating resin portion 51C. Therefore, even if the bending angle of the outer connecting portion 32 to the hole insertion portion 31 varies for each terminal 3, the mold in a closed state cannot directly press the back surface 321 of the outer connecting portion 32 toward the case front-surface side CF during injection molding to integrally mold the insulating resin member 5C with the current collecting terminal 3 and the case lid 4. This makes it impossible to correct the bending angle of the outer connecting portion 32 with respect to the hole insertion portion 31. As a result, the molten resin YJ for forming the insulating resin member 5 may enter into the gap between the front surface 323 of the outer connecting portion 32 and the mold contact portion of the mold, causing the generation of resin burrs JB extending from the outer-periphery-side insulating resin portion 53 onto the front surface 323 of the outer connecting portion 32.

With the above-described configuration, the power storage device 10 provided in the present embodiment can avoid or reduce the generation of resin burrs of the insulating resin member 5, which is integrally molded with the current collecting terminal 3 and the case lid 4, on the front surface 323 of the outer connecting portion 32 of the current collecting terminal 3.

### Method for Manufacturing the Power Storage Device

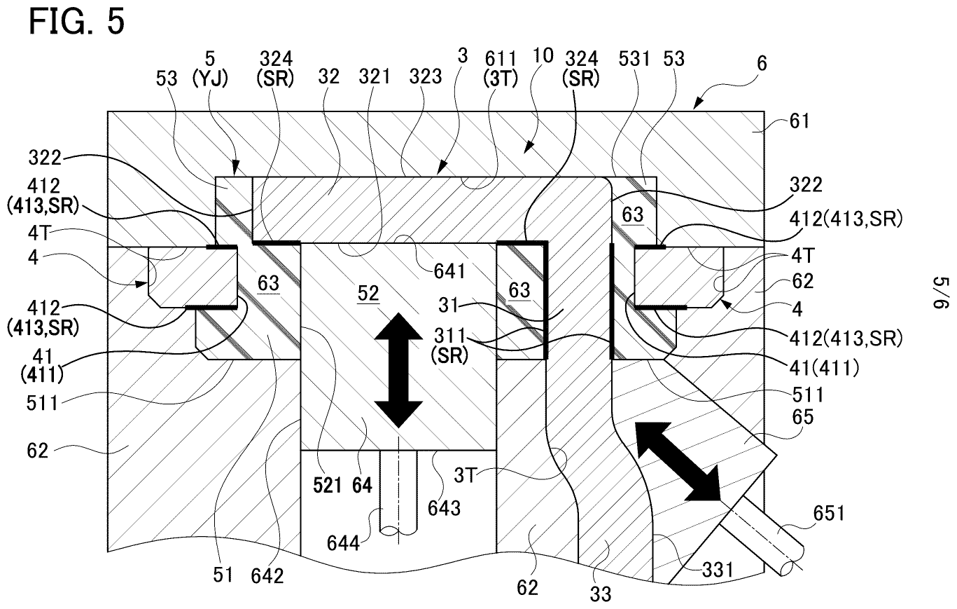

A method for manufacturing the power storage device 10 in the embodiment according to the disclosure will be described below, referring to the drawings. FIG. 5 is a cross-sectional view of a mold used in this manufacturing method.

The manufacturing method for the power storage device 10 uses a mold 6 including a fixed mold 61 and a movable mold 62, each having mold contact portions 3T and 4T to be placed in contact with the current collecting terminal 3 and the case lid 4 respectively, and cavities 63 in which the molten resin YJ forming the insulating resin member 5 is to be charged, as shown in FIG. 5. The mold 6 is connected to an injection molding device (not shown) that supplies molten resin into the cavity 63 corresponding to a resin injection portion (a gate portion) 54. The fixed mold 61 is provided with a mold contact portion 611 (one of the mold contact portions 3T), which contacts with the front surface 323 of the outer connecting portion 32 when the current collecting terminal 3 is set in the mold 6. Those fixed mold 61 and movable mold 62 are separated on the upper surface of the case lid 4 as a boundary. Further, the movable mold 62 is provided with a first pressing part 64 for pressing the outer connecting portion 32 toward the case front-surface side CF. This pressing part 64 has a prismatic columnar shape, and includes a distal end 641 to be placed in contact with the back surface 321 of the outer connecting portion 32 and side walls 642 to be placed in contact with the outer edge portion 521 of the hollow portion 52. The pressing part 64 can also act as an ejector, which is held in a stand-by position to contact with the back surface 321 of the outer connecting portion 32 at the time of setting the current collecting terminal 3 in the movable mold 62, and is moved forward towards the case front-surface side CF at the time of releasing the insulating resin member 5 from the mold 6 opened after molding.

In the present embodiment, the pressing part 64 is configured to be movable in the case front-back direction by a first driving mechanism 644 connected to a proximal end 643 located on the case back-surface side CB, but may be configured to be fixed to the movable mold 62. The pressing part 64 may be tapered so that its distal end 641 is slightly narrower than the proximal end 643 to improve the mold releasability of the insulating resin member 5. Furthermore, the movable mold 62 is provided with a second pressing part 65, which is placed in contact with an outer side surface 331 of a curved portion 33 of the current collecting terminal 3, extending from the hole insertion portion 31 toward the case back-surface side CB, to press the curved portion 33 against the corresponding mold contact portion 3T of the movable mold 62. The second pressing part 65 is connected to a second driving mechanism 651 and thus caused to advance to a position in contact with the curved portion 33 after the current collecting terminal 3 is set in the movable mold 62 and then to retract to a position not interfering with the curved portion 33 before the insulating resin member 5 is released after molding.

Moreover, while the molten resin YJ for the insulating resin member 5 is being charged into the mold 6 to fill the cavities 63, the pressing part 64 presses the back surface 321 of the outer connecting portion 32 on the inner circumferential side of the roughened surface 324 (the sealing portion SR) toward the case front-surface side CF, that is, against the fixed mold 61 placed on the case front-surface side CF. This can correct the bending angle of the outer connecting portion 32 with respect to the hole insertion portion 31 and reduce a gap between the front surface 323 of the outer connecting portion 32 and the mold contact portion 611 (3T) to zero or minute. Consequently, the molten resin YJ, which forms the insulating resin member 5, is not allowed to enter into the gap between the front surface 323 of the outer connecting portion 32 and the mold contact portion 611 (3T). This can avoid or reduce the generation of resin burrs JB extending from the outer-periphery-side insulating resin portion 53 onto the front surface 323 of the outer connecting portion 32.

### Modified Examples

The foregoing embodiments are mere examples and give no limitation to the present disclosure. The present disclosure may be embodied in other specific forms without departing from the essential characteristics thereof. For instance, in the power storage device 10 shown in FIG. 3, the front surface 323 of the outer connecting portion 32, located on the case front-surface side CF, and the front surface 531 of the outer-periphery-side insulating resin portion 53, located on the case front-surface side CF, are connected so as to be flush with each other, but is not limited thereto.

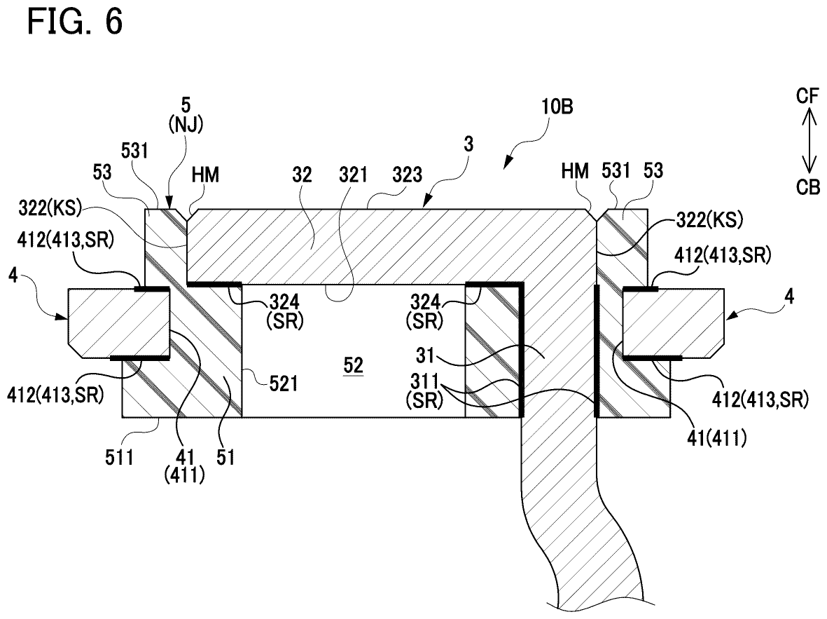

For example, as shown in FIG. 6, a power storage device 10B may be configured such that the front surface 323 of the outer connecting portion 32 and the front surface 531 of the outer-periphery-side insulating resin portion 53 are formed on the same plane as each other and further formed with a recessed groove HM on a boundary line KS between the outer connecting portion 32 and the outer-periphery-side insulating resin portion 53. Since the recessed groove HM (e.g., a recessed groove having a V-shaped cross-section) is formed on the boundary line KS between the outer connecting portion 32 and the outer-periphery-side insulating resin portion 53, a protruding mold contact portion that fits in the recessed groove HM can block off the molten resin YJ forming the insulating resin member 5, so that the molten resin YJ is more unlikely to enter into a gap between the front surface 323 of the outer connecting portion 32 and the mold contact portion 611 (3T). This can further avoid or reduce the generation of resin burrs JB extending from the outer-periphery-side insulating resin portion 53 onto the front surface 323 of the outer connecting portion 32. The recessed groove HM has a V-shaped cross-section in FIG. 6, but may have a curved or U-shaped cross-section. This recessed groove HM can increase the creepage distance between the current collecting terminal 3 and the case lid 4 in the insulating resin member 5, which can further enhance the insulation property.

### REFERENCE SIGNS LIST

3 Current collecting terminal
3T Mold contact portion
4 Case lid
4T Mold contact portion
5 Insulating resin member
6 Mold
10, 10B Power storage device
31 Hole insertion portion
32 External connection portion
41 Terminal inserting hole
51 Back-side insulating resin portion
52 Hollow portion
53 Outer-periphery-side insulating resin portion
61 Fixed die
62 Movable die
63 Cavity
64 Pressing part
321 Back surface
322 Outer periphery edge
323 Front surface
324 Roughened surface
411 Hole outer edge portion
412 Hole surrounding portion
511 Back surface
521 Outer edge portion
531 Front surface
HM Recessed groove
KS Boundary line
SR Scaling portion
YJ Molten resin

What is claimed is:

1. A power storage device comprising:
a case member having a terminal inserting hole;
a current collecting terminal including:
a hole insertion portion inserted through the terminal inserting hole in a case front-back direction of the case member; and
an external connection portion bent with respect to the hole insertion portion and placed on a front surface side of the case member; and
an insulating resin member integrally molded with the current collecting terminal and the case member, in which the hole insertion portion and the external connection portion are connected to a hole outer edge portion and a hole surrounding portion of the terminal inserting hole of the case member,
wherein the insulating resin member includes:
an outer-periphery-side insulating resin portion surrounding an entire outer periphery edge of the outer connecting portion; and
a back-surface side insulating resin portion connecting a back surface of the outer connecting portion and the hole insertion portion to the hole outer edge portion and the hole surrounding portion,
the back-surface side insulating resin portion is formed with a hollow portion penetrating from a back surface of the back-surface side insulating resin portion to the back surface of the outer connecting portion in the case front-back direction, and
the back surface of the outer connecting portion is formed with a sealing portion extending in an annular band shape along an outer edge portion of the hollow portion.

2. The power storage device according to claim 1, wherein
a front surface of the outer connecting portion and a front surface of the outer-periphery-side insulating resin portion are flush with each other, and
the outer connecting portion and the outer-periphery-side insulating resin portion have a recessed groove formed on a boundary line between them.

3. A method for manufacturing the power storage device according to claim 1, using a mold including a fixed mold and a movable mold, each having a mold contact portion to be placed in contact with the current collecting terminal and the case member, and a cavity in which molten resin is to be charged to form the insulating resin member,
wherein the movable mold includes a pressing part configured to press the outer connecting portion toward a case front-surface side, and
wherein the method comprises:
placing the current collecting terminal and the case member in the mold so that the mold contact portions contact with the current collecting terminal and the case member; and
charging the molten resin into the cavity while pressing the back surface of the outer connecting portion on an inner circumferential side of the sealing portion by the pressing part.

4. A method for manufacturing the power storage device according to claim 2, using a mold including a fixed mold and a movable mold, each having a mold contact portion to be placed in contact with the current collecting terminal and the case member, and a cavity in which molten resin is to be charged to form the insulating resin member,
wherein the movable mold includes a pressing part configured to press the outer connecting portion toward a case front-surface side, and
wherein the method comprises:
placing the current collecting terminal and the case member in the mold so that the mold contact portions contact with the current collecting terminal and the case member; and
charging the molten resin into the cavity while pressing the back surface of the outer connecting portion on an inner circumferential side of the scaling portion by the pressing part.
